(19) United States
(12) Patent Application Publication
(10) Pub. No.: US 2010/0313408 A1
(43) Pub. Date: Dec. 16, 2010

(54) ARRANGEMENT OF A PIN IN A BORE AND METHOD FOR POSITIONING AND SECURING THE PIN IN THE BORE

(75) Inventor: Ralf Morlo, Saarbrucken (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/445,643

(22) PCT Filed: Oct. 10, 2007
(86) PCT No.: PCT/EP07/60774

§ 371 Date: Apr. 15, 2009

(30) Foreign Application Priority Data
Oct. 24, 2006 (DE) 10 2006 049 998.0

(51) Int. Cl. B23P 11/00

(52) U.S. Cl. 29/525.01

(57) ABSTRACT

An arrangement of a pin (1) in a bore (2) of a disk (3), in particular a planetary pin (1) in a guide disk (3) of a planetary gear carrier. The pin (1) is secured against rotation by being fixed in place with the disk (3). The pin (1) has at least one recess (6) on the front face in which material (3b) of the disk (3) is forced when the pin (1) is secured in place within the disk (3).

This application is a National Stage completion of PCT/EP2007/060774 filed Oct. 10, 2007, which claims priority from German patent application serial no. 10 2006 049 998.0 filed Oct. 24, 2006.

### FIELD OF THE INVENTION

The invention concerns an arrangement of a pin in a bore as well as a process for positioning and securing the pin.

### BACKGROUND OF THE INVENTION

Introducing pins, in particular planetary gear pins or rivet pins (for maintaining a spacing) into the bore of guide disks, and fixing these in place with the disks is known in connection with planetary carriers of planetary transmissions. Planetary pins have longitudinal and transverse bore, via which the bearing points of the planetary gears are supplied with oil. The planetary pins must therefore be aligned in their angular position with regard to the direction of rotation of the planetary carrier before they are fixed in place. Corrugations are therefore provided in the bore of the planetary carrier, into which the material of the planetary pin can be fixed as protection against torsion. A disadvantage of this is that the inclination and offset of the bore axis may be changed in this way. The alignment of the pins takes place with a known method by means of an assembly device which engages in the central oil bore and aligns the planetary pin. This method is only possible with large pin diameters, but not with small bore diameters.

EP 1 214 536 B1 discloses a planetary carrier consisting of two parallel arranged guide disks and spacers, which connect these by way of a rivet pin. The rivet pins have journals at their front faces which are inserted into bore of the guide disks and are finally secured. The material of the journal is pressed thereby radially outwardly and over the edge of the bore. The rivet pin is seated thereafter firmly within the bore and is fixed in an axial as well as a tangential direction. Planetary pins having oil bores—such as those mentioned above—are fixed in place in a similar way with the guide disks. It is disadvantageous in this connection that the material of the planetary pins is relatively hard and can therefore only be fixed in place with a corresponding use of force.

### SUMMARY OF THE INVENTION

It is an object of the invention to create a possibility for aligning the pin in the bore and a simplified, less expensive means of preventing torsion of the pin with respect to the disk in an arrangement of the initially mentioned type. It is also an object of the invention to make available a process for positioning and securing the pin against torsion.

According to the invention, the pin is provided with at least one indentation, preferably a groove, on its front face. The groove runs preferably in the direction of a diameter through the center point of the front face, that is, diametrically. The material of the disk, that is, the bore edge, is fixed in place into the outer, diametrically opposite regions of the groove, so that a positive locking between the pin and the disk, that is, a securing against torsion, is produced. The groove according to the invention allows also bringing the pin into a desired angular position by means of rotation with the aid of a suitable tool before fixing it in place, which is also possible with the tiniest diameters. The pin can thus be twisted like a screw with slotted head by means of a screwdriver. After being fixed in place, which is carried out by means of a suitable stamp to be advanced in axial direction, there is no further need for deburring, since the front face of the pin ends flush with the outer surface of the disk, or is slightly recessed with respect to the outer surface of the disk. Producing the groove into the front face of the pin is accomplished with only little expense. The groove located in the front face according to the invention fulfills thus two functions, namely, on the one hand, the possibility of the positioning, and on the other hand, the possibility of the protection against torsion by fixing. Instead of a groove arranged diametrically, two grooves arranged at right angles, or several grooves arranged, for example, in star shape, for example, can also be provided. Providing these recesses or shapes on the front face of the pin is also possible and included within the scope of the invention, which in turn makes possible engaging a tool therein for the purpose of twisting it, and, on the other hand, pressing the material of the adjacent bore edge therein when being fixed in place.

The invention is particularly advantageous for planetary pins having oil bores in the form of longitudinal and transversal bores, since these must be aligned with respect to the planetary carrier or its guide disks before being fixed in their angular position. It is advantageous when fixing the pins that the relatively soft material of the planetary carrier or the guide disk is pressed into the front-face groove of the planetary bolt. The relatively hard material of the planetary pin is not fixed. The pin can thus be hardened throughout.

The object of the invention is also achieved by means of a process, wherein a pin with front-face groove is aligned in the bores after being inserted into the bore or the planetary carrier, and is then fixed in place, which is carried out by axially directing a stamp. Fixing the pin requires less use of force due to the relatively soft material; lower deformation forces, which have a lesser effect on a transversal position or limitation of the planetary bolt axes, are achieved in this way. Fixing the pin in place does not cause burr to be formed, which would then have to be eliminated.

### BRIEF DESCRIPTION OF THE DRAWINGS

An embodiment of the invention is represented in the drawing and will be described in more detail below, wherein:

FIG. 1 shows a cross section of a pin in a bore;

FIG. 2a shows a partial section through the pin according to FIG. 1;

FIG. 2b shows a partial section of the pin; and

FIG. 2c shows a plan view, that is, the front face of the bolt.

### DETAILED DESCRIPTION OF THE PREFERRED EMBODIMENTS

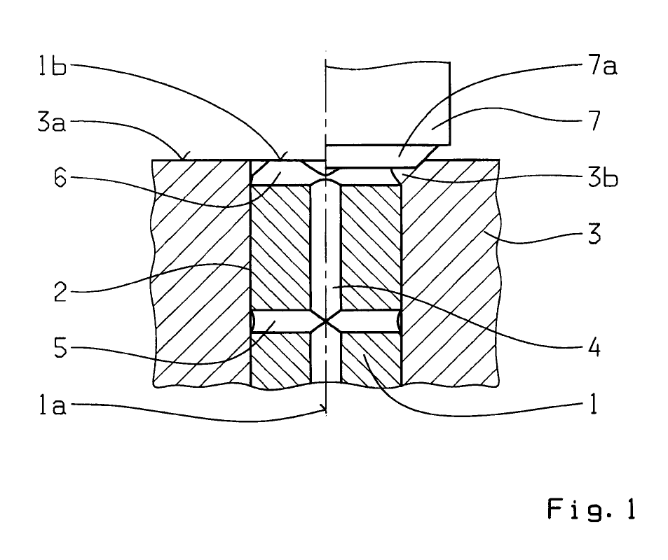

FIG. 1 shows a partially represented planetary pin 1, which is arranged in a bore 2 of a likewise only partially represented guide disk 3 of a planetary carrier, which is not represented. The planetary pin 1 has a longitudinal axis 1a and a front face 1b, which is approximately flush with the outer surface 3a of the guide disk 3 before final assembly. A longitudinal bore 4 is coaxial with the longitudinal axis 1a and a transverse bore 5 for supplying oil to bearing points of the planetary gears, which are not shown, are arranged in the planetary pin 1. A groove 6, which is penetrated by the longitudinal bore 4 and runs transversely to the longitudinal axis 1a, is incorporated into the front face 1b. The arrangement represented to the left of the longitudinal axis 1a in the drawing shows the planetary pin 1 in its initial position; the arrangement represented to the right of the longitudinal axis 1a in the drawing shows the planetary pin 1 after being fixed in place by means of a fixing tool configured as a stamp 7. The stamp 7 has a front face 7a configured approximately in the shape of a truncated cone, and is fed in direction of the longitudinal axis 1a, that is, it presses, on the one hand, against an edge region 3b of the guide disk 3 that surrounds the bore 2 and, on the other hand, on the front face 1b, which is repositioned by means of the feeding motion of the stamp 7, 7a. The material of the guide disk 3 is pushed at the same time out of the edge region 3b into the front-face groove 6, as shown in the drawing. In this way a positive locking connection is produced between the planetary pin 1 and the guide disk 3, so that the planetary pin 1 is secured against torsion and is also fixed in axial direction. The pin 1 can be adjusted around the longitudinal axis 1a before being fixed in place by means of a tool, which is not depicted and which engages in the longitudinal groove 6 from the front face, that is, which can be brought into a desired angular position. The previously described fixing follows.

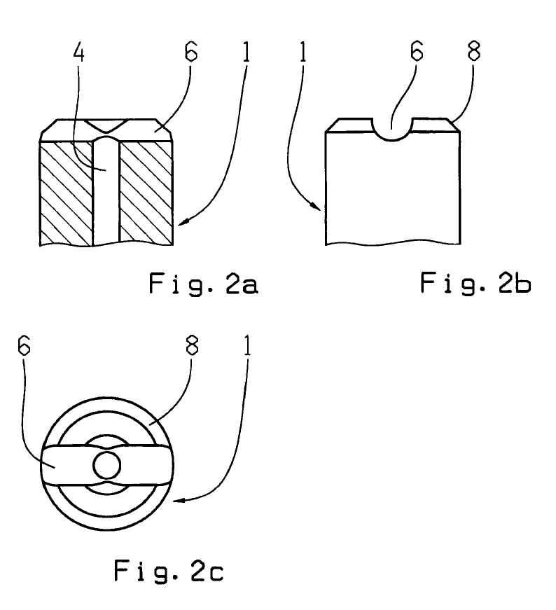

FIGS. 2a, 2b and 2c show the planetary pin 1 according to FIG. 1 as a single part, but only partially, in longitudinal section (FIG. 2a), elevated view (FIG. 2b), and plan view (FIG. 2c). The same reference numerals are utilized for parts identical to those seen in FIG. 1. FIG. 2b shows the profile of the longitudinal groove 6, which has an approximately U-shaped configuration. FIG. 2c shows the diametrical arrangement of the front-face groove 6, that is, it runs in direction of a diameter and is thus penetrated by the longitudinal bore 4. FIGS. 2b and 2c show a bevel 8 on the front face of the planetary pin 1, by means of which the assembly is facilitated.

The invention is neither limited to the planetary pin nor to the above-represented embodiment, but rather deviations or other embodiments are conceivable, which fulfill the functions according to the invention that reside, on the one hand, in an adjustability of the pin and, on the other hand, in the subsequent protection against torsion. It is particularly important in this connection that the material of the disk or bore edge to be fixed in place, that is, plastically deformed, and not the material of the planetary bolt, as is the case in the state of the art. The material of the disk is as a rule softer in these arrangements, while the pin, in particular the planetary pin, is made in general of harder material or is hardened after it is manufactured. It is also possible to conceive alternative recesses or shapes over the periphery or the front face of the pin, in which the material of the bore edge can flow inward from outside when being fixed in place.

### REFERENCE CHARACTERS

1 Planetary pin
1a Longitudinal axis
1b Front face
2 Bore
3 Guide washer
3a Outer side
3b Edge region
4 Longitudinal bore
5 Transversal bore
6 Front-face groove
7 Stamp
7a Front region
8 Bevel

1-8. (canceled)

9. A method for positioning and securing a pin (1) in a bore (2) against torsion in a disk (3), in particular a planetary pin (1) in a guide disk (3) of a planetary carrier, wherein the pin (1) is secured against torsion by being fixed with the disk (3), and the pin (1) having at least one front-face recess (6), the method comprising the steps of:
introducing the pin (1) into the bore (2),
engaging a tool in the front-face recess (6) which is aligned with reference to its position, and/or
pressing the material of the disk (3) into the front-face recess of the planetary pin (1) by fixing the edge region (3b) of the bore (2), while the pin is not caulked.

10. A method of positioning and securing a planetary pin (1) against rotation within a bore (2) of a guide disk (3) of a planetary gear carrier, and the planetary pin (1) having a front-face (1b) with at least one recess (6), the method comprising the steps of:
introducing the planetary pin (1) within the bore (2) of the guide disk (3) such that the front-face (1b) of the planetary pin (1) is flush with an outer surface (3a) of the guide disk (3);
inserting a means into the at least one recess (6) in the front-face (1b) of the planetary pin (1) to rotate and align the planetary pin (1) in a desired orientation; and
deforming an edge region (3b) of the outer surface (3a) of the guide disk (3), adjacent the bore (2), such that material of the guide disk (3) is pressed into the at least one recess (6) in the front-face (1b) of the planetary pin (1) to rotationally and axially fix the planetary pin (1) in position within the bore (2) of the guide disk (3).

11. The method according to claim 11, further comprising the step of forming the planetary pin (1) with a material that is less malleable than a material forming the edge region (3b) of the outer surface (3a) of the guide disk (3).

12. The method according to claim 11, further comprising the step of applying a force with a front face of a stamp (7) on the edge region (3b) of the outer surface (3a) of the guide disk (3), adjacent the bore (2), to deform and press the material of the guide disk (3) into the at least one recess (6) in the front-face (1b) of the planetary pin (1).

13. A method of securing a planetary pin (1) against rotation within a bore (2) of a guide disk (3) of a planetary gear carrier, and the planetary pin (1) having a front-face (1b) with at least one recess (6), the method comprising the steps of:
introducing the planetary pin (1) within the bore (2) of the guide disk (3);
inserting a tool into the at least one recess (6) in the front-face (1b) of the planetary pin (1) to align the planetary pin (1) in a desired orientation; and
deforming an edge region (3b) of the outer surface (3a) of the guide disk (3), adjacent the bore (2), such that material of the guide disk (3) is pressed into the at least one recess (6) in the front-face (1b) of the planetary pin (1) to affix the planetary pin (1) in position within the bore (2).
